(19) United States
(12) Patent Application Publication
(10) Pub. No.: US 2007/0073714 A1
(43) Pub. Date: Mar. 29, 2007

(54) Information providing server, information providing system, information providing method and information providing program

(75) Inventors: Nobuo Kawakami, Tokyo (JP); Masato Horinouchi, Tokyo (JP); Kazuo Hayakawa, Tokyo (JP)

Correspondence Address: GREENBLUM & BERNSTEIN, P.L.C., 1950 ROLAND CLARKE PLACE, RESTON, VA, 20191, US

(73) Assignee: Dwango Co., Ltd., Tokyo (JP)

(21) Appl. No.: 11/239,126

(22) Filed: Sep. 30, 2005

(30) Foreign Application Priority Data
Sep. 27, 2005 (JP) 2005-280641

(51) Int. Cl. G06F 17/30

(52) U.S. Cl. 707/10

(57) ABSTRACT

The objective of the present invention is to distribute a variety of information to a user without the user being forced to perform an unnecessary operation, so that the effects produced by information distribution can be improved. An email, which serves as a search trigger, is received from a portable phone and a search query is extracted from the email, multiple predesignated searches of different types are then performed, in accordance with the search query, and based on multiple search results obtained by the searches, multiple reply email messages are generated, for which the transmission source address of the received email is regarded as the reply destination, and the reply email messages are transmitted to the reply destination.

The present disclosure relates to subject matter contained in Japanese Patent Application No. 2005-280641, filed on Sep. 27, 2005, the disclosure of which is expressly incorporated herein by reference in its entirety.

### BACKGROUND OF THE INVENTION

1. Field of the Invention

The present invention relates to an information providing server for interacting with an action performed by a user, such as an information search, and using email to separately distribute an advertisement and information concerning the search results, an information providing system, an information providing method and an information providing program.

2. Description of the Related Background Art

In consonance with the recent, rapid development of the Internet, and based on the ready availability of information this development has made possible, the lives of people have been greatly changed. That is, the Internet has become an information transmission medium people can use to obtain information as desired, at any time and in any place, and it is notable that there has been an increase in the number of cases wherein first-time users, general consumers, have employed the Internet simply to acquire information.

In this situation, companies have found that using the Internet to provide information has become increasingly important, and as a result, many companies have set up home pages on the web. However, the mere act, by a company, of setting up a home page is insufficient, for users must be encouraged to voluntarily access the company web site, and thus, further active employment of the Internet by the company is required to promote sales through advertising.

An email-Magazine is one example form intended to promote more active use of the Internet. As is well known, an email-Magazine is a system that provides for the insertion of information, such as news and advertisements, into the text of an email that is thereafter distributed to multiple readers. According to the email-Magazine principles of use, a variety of information can be distributed to users without the users having to trace WWW (World Wide Web) links to access a company site. Therefore, an email-Magazine is an effective means for disseminating information using the Internet.

However, in this case, advertisements are transmitted to users without any consideration being given to the recipients' preferences, and since an advertisement usually constitutes only part of an email, and since the text of an email is seldom relevant to an advertisement, the advertising effectiveness is not very high.

To achieve a distribution of advertisements for which included information has a high browsing rate, an advertisement related information distribution system proposed in Japanese Patent Laid-Open Publication No. 2002-63100 includes: a user database, in which various types of user information, including email addresses, are stored in correlation with user identification codes; and an advertisement related information database, in which multiple sets of information for advertisements are stored in correlation with data for users to whom the information is to be disseminated. According to this advertisement related information distribution system: user data from the user database is obtained by the sender of an email and examined; the information for the advertisement that is to be disseminated to users corresponding to the user data is extracted from the advertisement related information database; and an email is prepared, by inserting the extracted advertisement related information into the head portion, and is transmitted to the terminal of the email sender.

However, according to the system disclosed in Japanese Patent Laid-Open Publication No. 2002-63100, since advertisement related information is distributed in consonance with user information based, for example, on the age, sex and tastes of a user, the advertisement content is limited.

Furthermore, since the advertisement related information is inserted into the head of an email, a user must read the information for an advertisement before proceeding to the text. Thus, a user who does not desire to read advertisement related information must scroll down the screen to read the contents of the text, and this is an unnecessarily demanding operation.

Further, since it is also probable that a user will immediately change the screen to avoid the advertisement related information and read only the contents of the text, the effectiveness of the distribution of new information, such as news and advertisements, is reduced.

### SUMMARY OF THE INVENTON

While taking this situation into account, the is objectives of the present invention are to provide an information providing server that distributes various types of information to users without forcing the users to perform unnecessary operations, so as to increase the effects produced by the distribution of information, and an information providing system, an information providing method and an information providing program.

According to the present invention, an information providing server comprises:

a reception unit, for receiving, from a portable terminal, an email to be used as a search trigger;

an extraction unit, for extracting a search query from the email received by the reception unit;

a search unit, for performing multiple different types of predesignated searches in accordance with the search query extracted by the extraction unit;

a generation unit, for, based on multiple sets of search results obtained by the search unit, generating multiple reply email messages for a transmission source address, as a reply email destination, for the email received by the reception unit; and

a transmission unit, for transmitting, to the reply email destination, the multiple reply email messages generated by the generation unit.

The multiple different types of predesignated searches may include a dictionary search.

The multiple different types of predesignated searches may include an advertisement search.

To generate a reply email based on advertisement search results, the generation unit may set, as a transmission source address, the address of a sponsor corresponding to the advertisement search results.

The multiple different types of predesignated searches may include a news search.

The search unit may perform a news search in accordance with the time whereat the reception unit received an email.

An email used as a search trigger may include a search query.

The information providing server further comprises:

a storage unit, for storing reply email destinations in correlation with search results; and

a determination unit, for examining correlated email destinations stored in the storage unit to determine whether a reply email should be transmitted.

The search unit may perform a search in an accessible database.

According to the present invention, an information providing system comprises:

a portable terminal; and

an information providing server including
a reception unit, for receiving, from a portable terminal, an email to be used as a search trigger,
an extraction unit, for extracting a search query from the email received by the reception unit,
a search unit, for performing multiple different types of predesignated searches in accordance with the search query extracted by the extraction unit,
a generation unit, for, based on multiple sets of search results obtained by the search unit, generating multiple reply email messages for a transmission source address, as a reply email destination, for the email received by the reception unit, and
a transmission unit, for transmitting, to the reply email destination, the multiple reply email messages generated by the generation unit.

The multiple different types of predesignated searches may include a dictionary search.

The multiple different types of predesignated searches may include an advertisement search.

To generate a reply email based on advertisement search results, the generation unit may set, as a transmission source address, the address of a sponsor corresponding to the advertisement search results.

The multiple different types of predesignated searches may include a news search.

The search unit may perform a news search in accordance with the time whereat the reception unit received an email.

An email used as a search trigger may include a search query.

The information providing server may further include:

a storage unit, for storing reply email destinations in correlation with search results; and

a determination unit, for examining correlated email destinations stored in the storage unit to determine whether a reply email should be transmitted.

The search unit may perform a search in an accessible database.

According to the present invention, an information providing method comprises:

receiving, from a portable terminal, an email to be used as a search trigger;

extracting a search query from the received email;

performing multiple different types of predesignated searches in accordance with the search query that is extracted;

based on multiple sets of search results that are obtained, generating multiple reply email messages for a transmission source address, as a reply email destination, for the received email; and

transmitting, to the reply email destination, the multiple reply email messages that are generated.

The multiple different types of predesignated searches may include a dictionary search.

The multiple different types of predesignated searches may include an advertisement search.

To generate a reply email based on advertisement search results, the address of a sponsor corresponding to the advertisement search results may be set as a transmission source address.

The multiple different types of predesignated searches may include a news search.

A news search may be performed in accordance with a reception time of an email.

An email used as a search trigger may include a search query.

The information providing method further comprises the steps of:

storing reply email destinations in correlation with search results; and

examining correlated email destinations that are stored to determine whether a reply email should be transmitted.

The information providing method may further comprise a step of performing a search in an accessible database.

According to the present invention, an information providing program that is capable of executing an information providing method comprises;

receiving, from a portable terminal, an email to be used as a search trigger;

extracting a search query from the received email;

performing multiple different types of predesignated searches in accordance with the search query that is extracted;

based on multiple sets of search results that are obtained, generating multiple reply email messages for a transmission source address, as a reply email destination, for the received email; and

transmitting, to the reply email destination, the multiple reply email messages that are generated.

The multiple different types of predesignated searches may include a dictionary search.

The multiple different types of predesignated searches may include an advertisement search.

To generate a reply email based on advertisement search results, the address of a sponsor corresponding to the advertisement search results may be set as a transmission source address.

The multiple different types of predesignated searches may include a news search.

A news search may be performed in accordance with a reception time of an email.

An email used as a search trigger may include a search query.

The information providing program may further comprise the steps of:

storing reply email destinations in correlation with search results; and

examining correlated email destinations that are stored to determine whether a reply email should be transmitted.

The information providing program may further comprise a step of performing a search in an accessible database.

According to the information providing server, the information providing system, the information providing method and the information providing program of the invention, an email to be used as a search trigger is received from a portable terminal; a search query is extracted from the received email; multiple different types of predesignated searches are performed in accordance with the search query; based on multiple sets of obtained search results, multiple reply email messages for a transmission source address are generated as a reply email destination for the received email; and the multiple reply email messages that are generated are transmitted to the reply email destination. Thus, various types of information can be distributed to users without forcing the users to perform unnecessary operations, and the effects produced by the distribution of information can be increased.

### BRIEF DESCRIPTION OF THE DRAWINGS

FIG. 1 is a diagram for explaining an overview of an information providing system according to one embodiment of the present invention;

FIG. 2 is a detailed diagram for explaining an information providing server in FIG. 1;

FIG. 3 is a detailed diagram for explaining a keyword extraction table referred to by an extraction function in FIG. 2;

FIG. 4 is a detailed diagram for explaining a data table in FIG. 2;

FIG. 5 is a detailed diagram for explaining a history table in FIG. 2;

FIG. 6 is a flowchart for explaining an information providing method performed by the information providing server in FIG. 1;

FIG. 7 is a flowchart for explaining the main search processing performed by the information providing server in FIG. 1;

FIG. 8 is a flowchart for explaining the advertisement search processing performed by the information providing server in FIG. 1;

FIG. 9 is a flowchart for explaining the news search processing performed by the information providing server in FIG. 1;

FIG. 10 is diagram for explaining the information providing method performed by the information providing server in FIG. 1;

FIG. 11 is diagram for explaining the information providing method, performed by the information providing server in FIG. 1, for a case wherein a user has sent to the information providing server an email in which “dictionary PC” is indicated; and

FIG. 12 is diagram for explaining the information providing method, performed by the information providing server in FIG. 1, for a case wherein a user has sent to the information providing server an email in which “travel Kusatsu” is indicated.

### DESCRIPTION OF THE EMBODIMENTS

According to one embodiment of the present invention, an email to be used as a search trigger is received from a portable terminal; a search query is extracted from the received email; multiple different types of predesignated searches are performed in accordance with the search query; based on multiple sets of obtained search results, multiple reply email messages for a transmission source address are generated as a reply email destination for the received email; and the multiple reply email messages that are generated are transmitted to the reply email destination. Thus, various types of information can be distributed to users without forcing the users to perform unnecessary operations, and the effects produced by the distribution of information can be increased.

The details of the present invention will now be described while referring to the drawings.

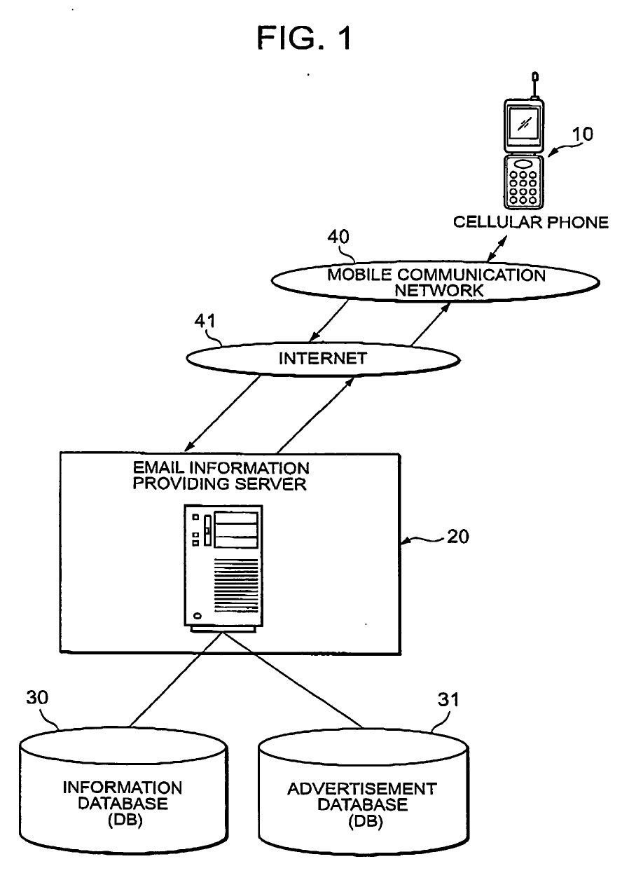

FIG. 1 is a diagram for explaining an overview of an information providing system according to the embodiment of the present invention.

The information providing system in FIG. 1 intermeshes with an action, such as an information search performed by a user, and distributes only information, such as news and advertisements, by sending a second email that differs from a first email that represents, for example, information search results. This information providing system includes a cellular phone 10, an email information providing server 20, an information database (DB) 30 and an advertisement DB 31.

The cellular phone 10 is a terminal device that can exchange email by communicating with the email information providing server 20 via a mobile communication network 40, for communication carriers, and via the Internet 41, which is a communication line. In this embodiment, the cellular phone 10 is employed as an example; however, a terminal device that can be used is not limited to the cellular phone 10, and may, for example, be a PDA that can exchange email.

In accordance with the contents of an email received from the cellular phone 10, the email information providing server 20 determines what information is desired by a user, and provides the pertinent information to the user by sending an email (a first email). Further, the email information providing server 20 also sends another email (a second email) to distribute only information, such as news and advertisements.

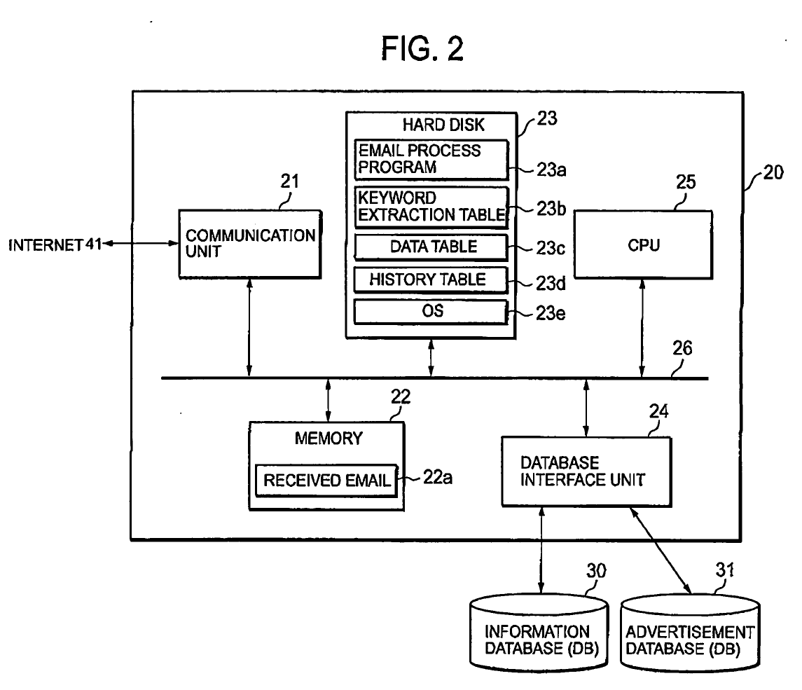

FIG. 2 is a detailed diagram for explaining the email information providing server 20. The email information providing server 20 includes a communication unit 21, a memory 22, a hard disk 23, a database interface unit 24 and a CPU 25.

The communication unit 21 uses packet switching to communicate with the cellular phone 10 via the Internet 41, and obtains data contained in email 22a that is received.

The memory 22 is used to store email 22a received from the cellar phone 10. The email 22a that is received may be stored temporarily, or the data contained therein may be shifted from the memory 22 to the hard disk 23 and stored for a specific period of time.

An email process program 23a, a keyword extraction table 23b, a data table 23c, a history table 23d and an OS (Operating System) 23e are stored on the hard disk 23. The keyword extraction table 23b, the data table 23c and the history table 23d will be described in detail later.

The database interface unit 24 is connected, for the exchange of data, to the information DB 30 and the advertisement DS 31. The CPU 25 controls the operations of the communication unit 21, the memory 22, the hard disk 23 and the database interface unit 24. It should be noted that the communication unit 21, the memory 22, the hard disk 23, the database interface unit 24 and the CPU 25 are connected by a bus 26.

The CPU 25 reads the email process program 23a to execute the reception function, the extraction function, the is search function, the generation function and the transmission function. The reception function receives from the cellular phone 10 an email that serves as a search trigger. The extraction function, which is used to extract a search query from an email received by the reception function, extracts a keyword from the contents of the received email 22a, stored in the memory 22, by referring to the keyword extraction table 23b.

The search function is used to perform different types of multiple, predesignated searches in accordance with the search query that is extracted by the extraction function. The generation function is a function for generating multiple reply email messages based on multiple search results obtained by the search function, while the transmission source address of the email received by the reception function is used as a reply destination. That is, the generation function generates an email (a first email) relevant to the search query forwarded by the user and an email (a second email) including news or an advertisement consonant with the action taken by the user. The transmission function is used to transmit to the reply destination multiple reply email messages generated by the generation function.

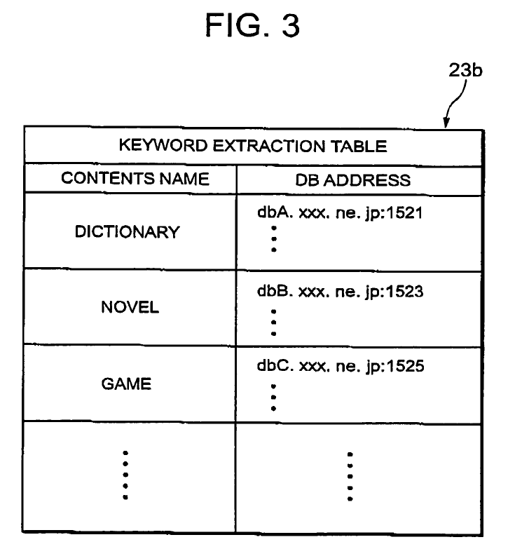

The keyword extraction table 23d referred to by the extraction function will now be described in detail while referring to FIG. 3. Multiple keywords such as “dictionary”, “novel” and “game” are registered as content names, and addresses “dbA.xxx.ne.jp:1521”, “dbB.xxx.ne.jp:1523” and “dbC.xxx.ne.jp:1525” are registered as addresses for the databases corresponding to the contents.

In this embodiment, the extraction function has referred to the keyword extraction table 23d. However, instead of this, the content names and database addresses may be included in the email process program 23a, and the email process program 23a may extract a keyword without referring to the keyword extraction table 23b.

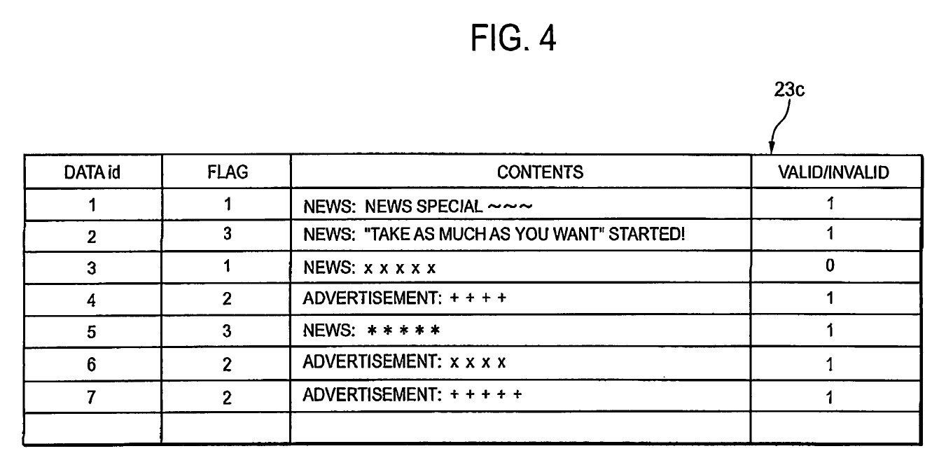

The data table 23c will now be explained in detail while referring to FIG. 4. Data ids for identifying data, flags indicating news types, contents and valid/invalid flags are entered in the data table 23c. In this case, news type “1”, indicated by the flag, is news, “2” is an advertisement and “3” is news. Further, “1”, indicated by the valid/invalid flag, is valid and “0” is invalid. Instead of the valid/invalid flag, an effective date and time may be entered.

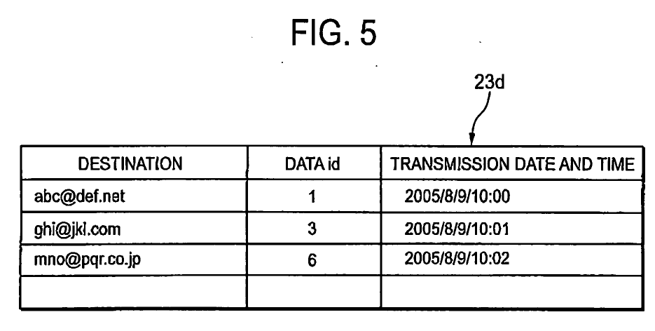

The history table 23d will now be explained in detail while referring to FIG. 5. Email addresses representing transmission destinations, data ids recorded in the data table 23c and transmission dates and times are entered in the history table 23d.

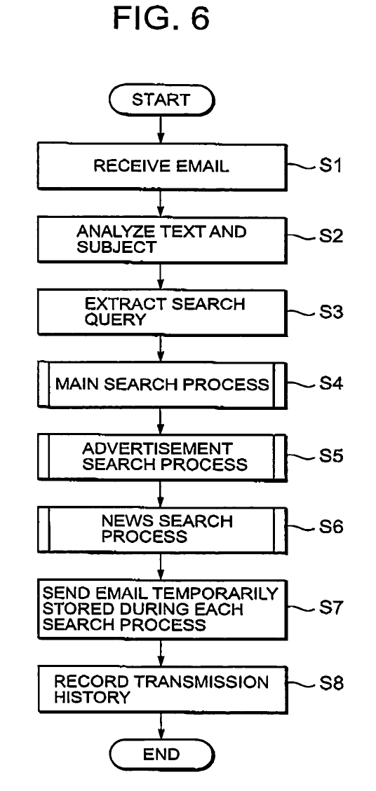

The information providing method performed by the email information providing server 20 will now be described. As shown in FIG. 6, first, a user uses the cellular phone 10 and transmits an email to the email information providing server 20 via the mobile communication network 40 and the Internet 41. In the email information providing server 20, the communication unit 21 receives the email from the user, and temporarily stores it as a received email 22a in the memory 22 (step S1).

In this embodiment, the received email 22a is stored temporarily only for the extraction of a keyword. Following this, the extraction function analyzes a Subject (title) in the title column of the email and the contents of the text in the email, and extracts a keyword (step S2).

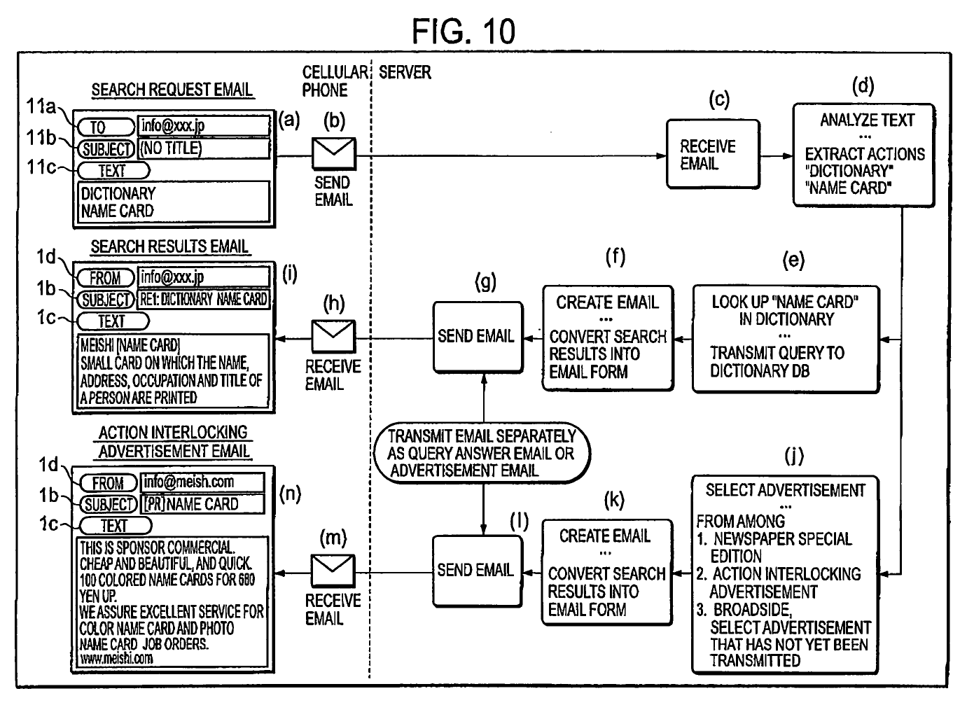

In this embodiment, assume that, as (a) in FIG. 10, the user employing the cellular phone 10 has entered for To (destination) 11a, info@xxx.jp, which is the address of the email information providing server 20, has left blank Subject (title name) 11b, and has entered “dictionary name card” as text 11c, and that such an email has been transmitted as (b) in FIG. 10 and has been received through the communication unit 21 as (c) in FIG. 10.

Then, as (d) in FIG. 10, the extraction function analyzes the contents of the Subject (title name) 11b and the text 11c and extracts a keyword. Since the Subject (title name) 11b of the first email is blank and “dictionary name card” is described as the text 11c, keywords are extracted only from the text 11c.

In this case, the extraction function extracts “dictionary” and “name card” as keywords. In addition, during an analysis performed by the extraction function, whether the keywords are correct is also decided by examining the keyboard extraction table 23b to determine whether the keywords are present therein. When it is determined that the keywords are not correct, an error email requesting a retransmission is sent to the cellular phone 10 of the user.

A rule for performing the analysis may be included in this error email. Furthermore, for deciding whether a keyword is correct, the email process program 23a may include content names and database addresses, and may determine whether the keyword is correct without referring to the keyword extraction table 23b.

When the extracted keywords are correct, as (e) in FIG. 10, data are obtained from the information DB 30 using, as a query, the keywords that were extracted by the extraction function (step S3). In this case, the query is used to indicate, for example, the performance of a search for “name card” information in the “dictionary”, and is used for the main search process that is performed (step S4).

When data are obtained from the information DB 30, as (f) in FIG. 10, the generation function converts the search results into an email form, as (g) in FIG. 10, the transmission function transmits the email to the cellular phone 10 that is the transmission source, and as (h) in FIG. 10, the cellular phone 10 receives the email. It should be noted that the search results obtained in the main search process are transmitted at the same time as an advertisement or news, which will be described later, are searched for and transmitted.

When the search results obtained in the main search process are received, as (i) in FIG. 10, “info@xxx.jp” is entered in “From” (the transmission source) 11d on the screen of the cellular phone 10, state information (Rel: dictionary name card) that is generated based on the query and represents the state of the user is displayed in the Subject (title name) 11b, and the definition of “name card” is displayed in the text 11c. “Re” at the head of the state information is a reply symbol, and the number “1” beside the reply symbol represents the reply count. However, “Re” is merely an example, and another character or symbol may be employed.

Also, when an email is received from the cellular phone 10, the data is read sequentially from the advertisement DB 31. Assume that the data id for which the flag indicates “2” in the data table 23c is searched for. When such a data id is present, it is determined that there is an advertisement, and based on the data id, the advertisement search process is performed for the advertisement DB 31 (step S5).

Further, assume that a data id for which the flag is “1” or “3” is searched for in the data table 23c. When such a data id is present, it is determined that there is news, and based on the data id, the news search process is performed for the advertisement DB 31 (step S6).

Thereafter, the email that is temporarily stored as a result of the main search process, the advertisement search process and the news search process are transmitted (step S7). Then, the transmission history for the search results obtained during the main search process, the advertisement search process and the news search process are stored in the history table 23d (step S8).

Specifically, as shown in FIG. 5, for the transmission destination abc@def.net, since the data id is “1”, the news were transmitted at 10:00 on the date Aug. 9, 2005. For the transmission destination ghi@jkl.com, since the data id is “3”, the news were transmitted at 10:01 on the date Aug. 9, 2005. For the transmission destination mno@pqr.co.jp, since the data id is “6”1, the advertisement was transmitted at 10:02 on the date Aug. 9, 2005.

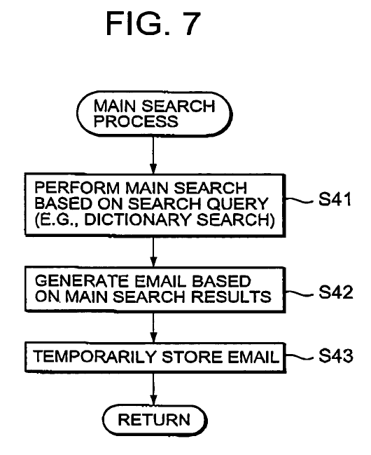

FIG. 7 is a flowchart showing the main search process at step S4 in FIG. 6. First, when the main search (e.g., the dictionary search) based on a search query is performed in the above described manner (step S41), an email is generated based on the main search results (step S42), and is temporarily stored (step S43).

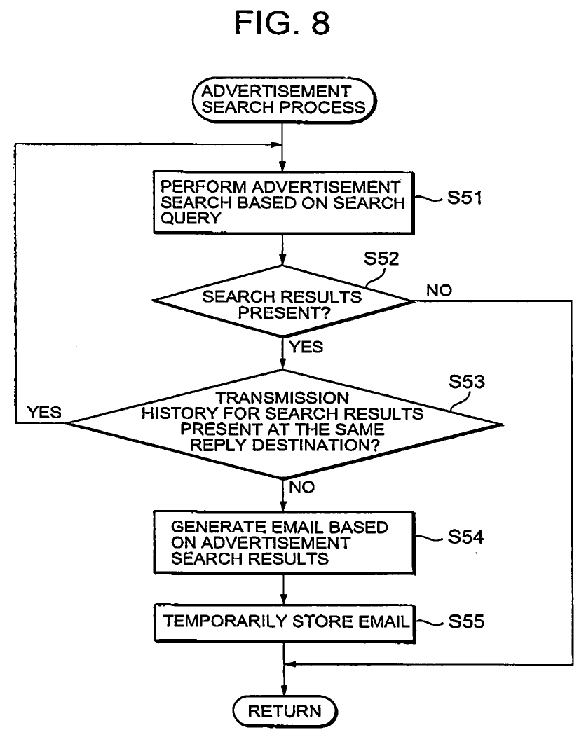

FIG. 8 is a flowchart showing the advertisement search process performed at step S5 in FIG. 6. First, based on a search query, an advertisement search is performed (step S51). When the search results are present (step S52), a check is performed to determine whether a transmission history for the transmission results is present in the history table 23d (step S53). When the transmission history is present, another advertisement search is performed.

That is, as described above, the history stored in the history table 23d is necessary for determining whether the transmission of pertinent data conforms to a predetermined transmission rule (e.g., the same advertisement should be transmitted only once a day). When the transmission destination in the history table 23d in FIG. 5 is, for example, “abc@def.net”, and when the data id is “1”, the flag in the data table 23c in FIG. 4 indicates the news is “1”, so the advertisement has not yet been transmitted.

When the search results obtained by the advertisement search are not present in the transmission history in the history table 23d, an email is generated based on the advertisement search results (step S54) and is temporarily stored (step S55).

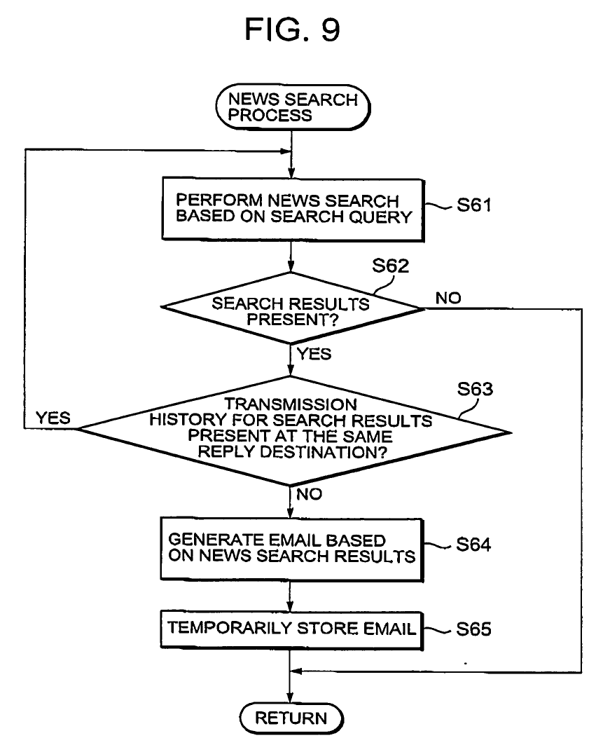

FIG. 9 is a flowchart showing the news search process at step S6 in FIG. 6. First, based on a search query, a news search is performed (step S61). When the search results are present (step S62), a check is performed to determine whether a transmission history for the transmission results is present in the history table 23d (step S63). When the transmission history is present, another news search is performed. The news search may be performed not only in accordance with the search query, but may also be based on the email reception time. This is because news changes as time elapses, and the latest news should constantly be distributed based on the email reception time.

That is, as in the above case, assume that the transmission destination in the history table 23d in FIG. 5 is, for example, “abc@def.net”. When “1” is entered as data id, since a flag indicating news is “1” in the data table 23c in FIG. 4, it is assumed that no news has as yet been transmitted.

When the search results obtained by the news search are not present in the transmission history of the history table 23d, an email is generated based on the news search results (step S64) and is temporarily stored (step S65).

When the search results obtained by the advertisement search are to be transmitted, as (j) in FIG. 10, an advertisement that is searched for is selected; as (k) in FIG. 10, the search results are converted into an email form; as (l) in FIG. 10, an advertisement email is transmitted by the transmission function to the cellular phone 10 of the user; and as (m) in FIG. 10, the email is received by the cellular phone 10.

At this time, as (n) in FIG. 10, on the screen of the cellular phone 10, “info@meishi.com” is displayed in “From” (the transmission source) 11d; “[PR] name card” is displayed in “Subject” (the title name) 11b; and the advertisement related to “name card” is displayed in the text 11c. [PR] at the head is a symbol representing an advertisement. However, the “PR” used at the head is merely an example, and another character or symbol may be employed.

An explanation will be given for the shifting of the screens of the cellular phone 10 performed when, intermeshing with the user's action for an information search, an advertisement is to be distributed separately using an email other than the one that is used for the information search results.

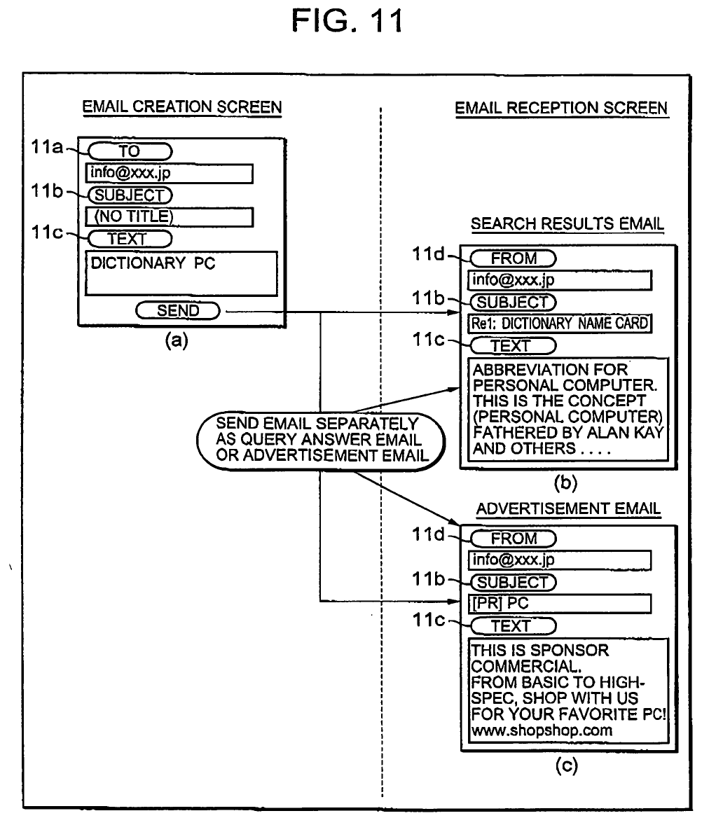

First, in an example (a) in FIG. 11, the user has transmitted an email for which the contents are “dictionary name card” to the email information providing server 20. Assume that the user has used the cellular phone 10 and has transmitted an email wherein “info@xxx.jp, which is the address of the email information providing server 20, is entered in “To” (the destination) 11a, “Subject” (the title name) 11b is left blank and “dictionary PC”, is entered as the text 11c.

In the email information providing server 20, the extraction function analyzes the contents of Subject (the title name) 11b and the text 11c, and extracts a keyword. In this case, since Subject (the title name) 11b in the first email is blank and “dictionary PC” is entered in the is text 11c, keyword extraction is performed for the text 11c.

The extraction function extracts “dictionary” and “PC” as keywords. During the analysis performed by the extraction function, whether the keywords are correct is decided by examining the keyword extraction table 23b to determine whether these keywords are present. When it is determined that the keywords are not correct, as described above, an error email requesting a retransmission is sent to the cellular phone 10 of the user.

When the extracted keywords are correct, data are obtained from the information D8 30 using, as a query, the keywords that are extracted by the extraction function. In this case, the query is used to indicate, for example, the performance of a search for “PC” information in the “dictionary”.

When data are obtained from the information DB 30, the generation function converts the search results into an email form (query answer email (a first email)), and the transmission function transmits this email to the cellular phone 10 that is the transmission source.

As a result, as (b) in FIG. 11, on the screen of the cellular phone 10, “info@xxx.jp” is displayed in From (the transmission source) 11d, the state information (Rel: dictionary PC) that is generated based on the query and represents the state of the user is displayed in Subject (the title name) 11b, and the definition for “PC” is displayed in the text 11c. It should be noted that, as described above, “Re” at the head of the state information is a reply symbol.

When an email is received from the cellular phone 10, the data is read sequentially from the advertisement DB 31. When the transmission of an advertisement for a sponsor is enabled as a result of referring to the history in the history table 23d, an email (a second email) that includes the read data from the advertisement DB 31 is generated, and the transmission function transmits the second email to the cellular phone 10 that is the transmission source.

As a result, as (c) in FIG. 11, on the screen of the cellular phone 10, “info@xxx.jp” is displayed in From (the transmission source) 11d, [PR] PC is displayed in Subject (the title name) 11b, and an advertisement related to “PC” is displayed in the text 11c. As described above, “PR” at the head is a symbol representing the advertisement.

As described above, according to the embodiment, an email that serves as a search trigger is received from the cellular phone 10, a search query is extracted from the email and multiple predesignated searches of different types are performed in accordance with the search query, and based on multiple search results obtained by the searches, multiple reply email messages are generated, for which the transmission source address of the received email is regarded as the reply destination, and the reply email messages are transmitted to the reply destination. Thus, a variety of information can be distributed to a user without the user being forced to perform an unnecessary operation, and the effects produced by information distribution can be improved.

Furthermore, in this embodiment, according to a predetermined transmission rule, the determination function determines whether transmission of data with an email is enabled, e.g., determines that transmission of the same contents should be performed only once a day (date designation can be changed). Therefore, the email distribution of spam to users can be prevented.

In this embodiment, an explanation has been given for the advertisement email, as (c) in FIG. 11, wherein “info@xxx.jp”, the email address of the email information providing server 20, is displayed in From (the transmission source) 11d. However, the email address of a sponsor may be used as the email address in From (the transmission source) 11d for the advertisement email.

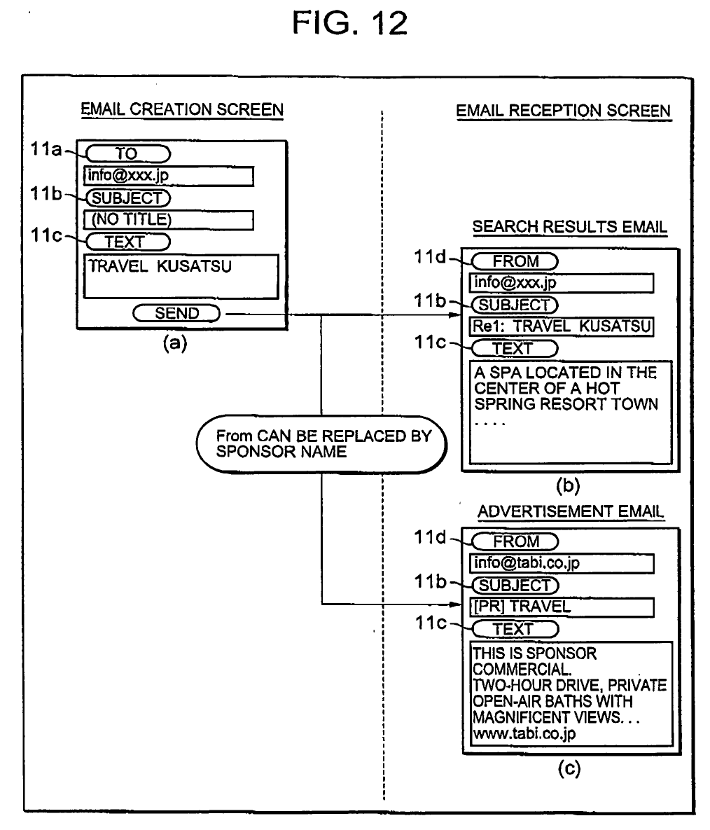

In this case, as (a) in FIG. 12, assume that the user has transmitted an email wherein “info@xxx.jp”, which the address of the email information providing server 20, is entered in To (the destination) 11a, Subject (the title name) 11b is left blank and “travel Kusatsu” is entered as the text 11c, and that keyword extraction is performed for the text 11c. Thus, “Travel” and “Kusatsu” are extracted as keywords.

Data are obtained from the information DB 30 using, as a query, the keywords that are extracted by the extraction function. The query indicates, for example, the performance of a search in the category “travel” for information about “Kusatsu”.

After data have been obtained from the information DB 30, the generation function converts the search results into an email form (query answer email (the first email)), and the transmission function separately transmits the first email from the advertisement email to the cellular phone 10 that is the transmission source. Then, as (b) in FIG. 12, on the screen of the cellular phone 10, “info@xxx.jp” is displayed in “From (the transmission source) 11d, the state information (Rel: dictionary PC) that is generated based on the query and represents the state of the user is displayed in Subject (the title name) 11b, and the definition of “Kusatsu” is displayed in the text 11c.

Similarly, when transmission of an advertisement by a sponsor is enabled as a result of referring to the history stored in the history table 23d, an email (a second email) that includes the read data from the advertisement DB 31 is generated, and the transmission function transmits the second email to the cellular phone 10 that is the transmission source.

In this case, as (c) in FIG. 11, the email address in From (the transmission source) 11d on the screen of the cellular phone 10 can be replaced with “info@tabi.co.jp”, which is the email address of a sponsor. Further, “[PR] is travel” is displayed in Subject (the title name) 11b, and an advertisement related to “travel” is displayed as the text 11c. In this manner, since the email address in From (the transmission source) 11d is replaced by “info@tabi.co.jp”, which is the email address of the sponsor, the received email can be regarded as an advertisement email directly transmitted from the sponsor.

The present invention can be applied for a general communication system that employs terminal devices having an email function.

What is claimed is:

1. An information providing server comprising:
a reception unit, for receiving, from a portable terminal, an email to be used as a search trigger;
an extraction unit, for extracting a search query from the email received by the reception unit;
a search unit, for performing multiple different types of predesignated searches in accordance with the search query extracted by the extraction unit;
a generation unit, for, based on multiple sets of search results obtained by the search unit, generating multiple reply email messages for a transmission source address, as a reply email destination, for the email received by the reception unit; and
a transmission unit, for transmitting, to the reply email destination, the multiple reply email messages generated by the generation unit.

2. An information providing server as set forth claim 1, wherein the multiple different types of predesignated searches includes a dictionary search.

3. An information providing server as set forth in claim 1, wherein the multiple different types of predesignated searches includes an advertisement search.

4. An information providing server as set forth in claim 3, wherein, to generate a reply email based on advertisement search results, the generation unit sets, as a transmission source address, the address of a sponsor corresponding to the advertisement search results.

5. An information providing server as set forth in claim 1, wherein the multiple different types of predesignated searches includes a news search.

6. An information providing server as set forth in claim 5, wherein the search unit performs a news search in accordance with the time whereat the reception unit received an email.

7. An information providing server as set forth in claim 1, wherein an email used as a search trigger includes a search query.

8. An information providing server as set forth in claim 1, further comprising;
a storage unit, for storing reply email destinations in correlation with search results; and
a determination unit, for examining correlated email destinations stored in the storage unit to determine whether a reply email should be transmitted.

9. An information providing server as set forth in claim 1, wherein the search unit performs a search in an accessible database.

10. An information providing system comprising;
a portable terminal; and
an information providing server including
a reception unit, for receiving, from a portable terminal, an email to be used as a search trigger,
an extraction unit, for extracting a search query from the email received by the reception unit,
a search unit, for performing multiple different types of predesignated searches in accordance with the search query extracted by the extraction unit,
a generation unit, for, based on multiple sets of search results obtained by the search unit, generating multiple reply email messages for a transmission source address, as a reply email destination, for the email received by the reception unit, and
a transmission unit, for transmitting, to the reply email destination, the multiple reply email messages generated by the generation unit.

11. An information providing system as set forth in claim 10, wherein the multiple different types of predesignated searches includes a dictionary search.

12. An information providing system as set forth in claim 10, wherein the multiple different types of predesignated searches includes an advertisement search.

13. An information providing system as set forth in claim 12, wherein, to generate a reply email based on advertisement search results, the generation unit sets, as a transmission source address, the address of a sponsor corresponding to the advertisement search results.

14. An information providing system as set forth in claim 10, wherein the multiple different types of predesignated searches includes a news search.

15. An information providing system as set forth in claim 14, wherein the search unit performs a news search in accordance with the time whereat the reception unit received an email.

16. An information providing system as set forth in claim 10, wherein an email used as a search trigger includes a search query.

17. An information providing system as set forth in claim 10, wherein the information providing server further includes:
a storage unit, for storing reply email destinations in correlation with search results; and
a determination unit, for examining correlated email destinations stored in the storage unit to determine whether a reply email should be transmitted.

18. An information providing system as set forth in claim 10, wherein the search unit performs a search in an accessible database.

19. An information providing method comprising:
receiving, from a portable terminal, an email to be used as a search trigger;
extracting a search query from the received email;
performing multiple different types of predesignated searches in accordance with the search query that is extracted;
based on multiple sets of search results that are obtained, generating multiple reply email messages for a transmission source address, as a reply email destination, for the received email; and
transmitting, to the reply email destination, the multiple reply email messages that are generated.

20. An information providing method as set forth in claim 19, whereby the multiple different types of predesignated searches includes a dictionary search.

21. An information providing method as set forth in claim 19, whereby the multiple different types of predesignated searches includes an advertisement search.

22. An information providing method as set forth in claim 21, whereby, to generate a reply email based on advertisement search results, the address of a sponsor corresponding to the advertisement search results is set as a transmission source address.

23. An information providing method as set forth in claim 19, whereby the multiple different types of predesignated searches includes a news search.

24. An information providing method as set forth in claim 23, whereby a news search is performed in accordance with a reception time of an email.

25. An information providing method as set forth in claim 19, whereby an email used as a search trigger includes a search query.

26. An information providing method as set forth in claim 19, further comprising the steps of;
storing reply email destinations in correlation with search results; and
examining correlated email destinations that are stored to determine whether a reply email should be transmitted.

27. An information providing method as set forth in claim 19, further comprising a step of performing a search in an accessible database.

28. An information providing program that is capable of executing an information providing method comprising:
receiving, from a portable terminal, an email to be used as a search trigger;
extracting a search query from the received email;
performing multiple different types of predesignated searches in accordance with the search query that is extracted;
based on multiple sets of search results that are obtained, generating multiple reply email messages for a transmission source address, as a reply email destination, for the received email; and
transmitting, to the reply email destination, the multiple reply email messages that are generated.

29. An information providing program as set forth in claim 28, whereby the multiple different types of predesignated searches includes a dictionary search.

30. An information providing program as set forth in claim 28, whereby the multiple different types of predesignated searches includes an advertisement search.

31. An information providing program as set forth in claim 30, whereby, to generate a reply email based on advertisement search results, the address of a sponsor corresponding to the advertisement search results is set as a transmission source address.

32. An information providing program as set forth in claim 28, whereby the multiple different types of predesignated searches includes a news search.

33. An information providing program as set forth in claim 32, whereby a news search is performed in accordance with a reception time of an email.

34. An information providing program as set forth in claim 28, whereby an email used as a search trigger includes a search query.

35. An information providing program as set forth in claim 28, further comprising the steps of:
storing reply email destinations in correlation with search results; and
examining correlated email destinations that are stored to determine whether a reply email should be transmitted.

36. An information providing program as set forth in claim 28, further comprising a step of performing a search in an accessible database.
